(19) United States
(12) Patent Application Publication
(10) Pub. No.: US 2015/0087753 A1
(43) Pub. Date: Mar. 26, 2015

(54) MODIFIED ASPHALT PAVING COMPOSITION

(71) Applicant: Western Emulsions, Inc., Dana Point, CA (US)

(72) Inventors: Robert KOLEAS, Dana Point, CA (US); Andrew CLAYTON, Dana Point, CA (US); Gary PORRITT, South Jordan, UT (US)

(21) Appl. No.: 14/493,881

(22) Filed: Sep. 23, 2014

Related U.S. Application Data
(60) Provisional application No. 61/881,084, filed on Sep. 23, 2013.

(51) Int. Cl. C09D 195/00; C08L 95/00

(52) U.S. Cl. CPC C09D 195/00; C08L 95/00; C08L 2555/80; C08L 2555/84
USPC 524/71; 524/59

(57) ABSTRACT

The present disclosure relates to asphalt paving compositions and methods of making and using the same.

### CROSS-REFERENCE TO RELATED APPLICATIONS

This application claims the benefit under 35 U.S.C. §119(e) of U.S. Provisional Patent Application No. 61/881,084, filed on Sep. 23, 2013, the contents of which are incorporated herein by reference in their entirety.

### TECHNICAL FIELD

The present disclosure relates to asphalt paving compositions and methods of making and using the same.

### BACKGROUND

Asphalt used for paving roads is sourced from refineries throughout the world. A recent trend in the refining industry has produced poor quality asphalts compared to those that were available 20 years ago. The poor quality asphalts currently being produced have led to a decrease in the quality of roads and other surfaces covered with asphalt that deteriorate quickly and require more repair and maintenance. Replacement or restoration of deteriorated roads is expensive. Consistent performance of restorative compositions across a broad range of temperature conditions depends upon higher quality asphalt formulations than are available today. There is thus a need for higher quality asphalt formulations that address these deficiencies.

The information included in this Background section of the specification is included for technical reference purposes only. It is not an admission that any of the information provided herein is prior art or relevant to the present disclosure, or that any information specifically or implicitly referenced is prior art.

### SUMMARY

The present disclosure is generally directed to asphalt paving compositions that accommodate the use of poor quality asphalt from any geographic location while still producing a low-cost asphalt paving composition that is workable, forgiving, tough, and durable over a wide range of temperatures.

In various aspects, the present disclosure is directed to asphalt paving compositions comprising an asphalt, a natural asphalt, one or more emulsifying agents, one or more rejuvenating agents, and one or more polymers. In some embodiments the natural asphalt may be an asphaltite such as Gilsonite. The asphalt paving compositions disclosed herein consistently meet paving industry performance criteria over a range of 86° C. or more, which is greater than existing formulations.

### DETAILED DESCRIPTION

The present disclosure is directed to formulations for, and methods of making and using, asphalt paving compositions. The compositions comprise an asphalt, a natural asphalt, an emulsifying agent, a rejuvenating agent, and one or more polymers. In various aspects, the natural asphalt is Gilsonite, the rejuvenating agent is Reclamite B, and the polymer is a PA-AS-1 polychloroprene polymer.

Asphalt

In various aspects, the asphalt paving compositions disclosed herein comprise asphalt (bitumen). The asphalt present in the disclosed formulations may be any emulsifiable asphalt known in the art.

Asphalt is comprised of an asphaltene fraction dispersed in a maltene fraction. The asphaltene fraction is insoluble in n-pentane and soluble in toluene. Molecular components of the asphaltene fraction are high in molecular weight, polarity and/or aromaticity. The maltene fraction can include resins, aromatic oils (aromatics) or saturate oils (saturates). The maltene fraction can include molecules ranging from non-polar, such as saturates, to polar, such as resins.

Asphalt in the asphalt paving compositions provided by the present disclosure can have original viscosity grades ranging from AC-1 to AC-30, as determined according to the AASHTO M-226 (www.transportation.org) or ASTM D-3381 (www.astm.org) protocols. The selected asphalt can depend on a variety of factors including, but not limited to, availability of material, climate (including maximum and minimum temperature during paving and of the setup road surface), and desired time for setup. For example, an AC-5 asphalt can be used for a fast set emulsion and/or a cold climate. As another example, an AC-10 to AC-20 asphalt can be used for a medium set emulsion. As a further example, an AC-20 to AC-30 asphalt can be used for a slow set emulsion and/or a hotter climate.

In various aspects, the asphalt in the asphalt paving compositions disclosed herein have a penetration between 20 dmm and 550 dmm.

Asphalt can be obtained from any region in the world. In the United States, asphalts can be obtained from any Petroleum Administration Defense District (PADD), including PADD 1, PADD 2, PADD 3, PADD 4 and PADD 5. Asphalt can also be acquired from any refiner or supplier. Examples of refiners and suppliers include, but are not limited to, Alon, BP, Calumet, Cenex, Conoco Phillips, Exxon/Mobil, Flint Hills Resources, Frontier, Holly, Husky, Imperial, Marathon, Montana Refining, Moose Jaw, Murphy Oil, NuStar, Paramount, San Joaquin, Shell, Silver Eagle, Sinclair, Suncor, Tesoro, US Oil, Valero, Western Refining, World, WRB and Wynnewood.

Natural Asphalt

In various aspects, the asphalt paving compositions disclosed herein also comprise one or more natural asphalts. A natural asphalt can comprise greater than 40% asphaltene content. The natural asphalts include, for example, asphaltite; lake asphalt such as trinidad asphalt; and rock asphalt. Asphaltites are characterized by a high softening point (above 110° C.). Asphaltites include uintahite (Gilsonite®), glance pitch, grahamite, and other similar materials. Uintahite is a natural, hard, thermoplastic hydrocarbon resin having a melting point of from about 130° C. to about 140° C., and a penetration at 77° F. (ASTM D-5-52) of less than one.

By combining asphalt with natural asphalt a modified asphalt can be generated, which displays a number of improved properties of the resulting formulations, including those below. As articulated herein, combining asphalt with natural asphalt to create a modified asphalt enhances the asphaltene content, improves low temperature flexibility, improves high temperature fatigue, increases anti-oxidant properties, and/or increases weathering properties of the modified asphalt compared to unmodified asphalt. Combining asphalt with natural asphalt to create a modified asphalt provides improved low temperature flexibility, improved high temperature fatigue, increased anti-oxidant properties, and/or increased weathering properties across a variety of asphalt sources compared to unmodified asphalt.

In various aspects, an asphalt paving composition provided by the present disclosure can comprise a modified asphalt in an amount of 45-70% of the total weight of the asphalt paving composition, a measurement that is also known as by weight of emulsion (BWE). In one embodiment, a modified asphalt is present in the composition in an amount of 52-65% BWE. In another embodiment, a modified asphalt for use in chip seal, scrub seal, or stress absorbing membrane interlayer (SAMI) seal asphalt paving compositions is present in the composition in an amount of 52-58% BWE. In another embodiment, a modified asphalt for use in cold in-place recycling or hot in-place recycling asphalt paving compositions is present in the composition in an amount of 58-65% BWE. In another embodiment, a modified asphalt for use in rejuvenating seal or texture seal asphalt paving compositions is present in the composition in an amount of 58-61% BWE.

In still another embodiment, a modified asphalt is present at greater than 45% BWE. In still another embodiment, a modified asphalt is present at greater than 50% BWE. In still another embodiment, a modified asphalt is present at greater than 55% BWE. In still another embodiment, a modified asphalt is present at greater than 60% BWE. In yet another embodiment, a modified asphalt is present at less than 70% BWE. In yet another embodiment, a modified asphalt is present at less than 65% BWE. In yet another embodiment, a modified asphalt is present at less than 60% BWE. In yet another embodiment, a modified asphalt is present at less than 55% BWE.

Emulsifying Agent

The asphalt paving compositions provided by the present disclosure may also include one or more emulsifying agents. Without being limited to any mechanism or mode of action, emulsifying agents hold asphalt particles in suspension and stabilize an emulsion. Reducing the amount of emulsifying agent in an emulsion can lead to a shorter setting time and/or shorter curing time during the paving process.

In various aspects, an asphalt paving composition provided by the present disclosure can comprise one or more emulsifying agents in an amount of 0.1-7.0% of the total weight of the asphalt paving composition, which is also known as by weight of emulsion (BWE). In one embodiment, one or more emulsifying agents are present in the composition in the amount of 0.25-5.0% BWE. In another embodiment, one or more emulsifying agents are present in the composition in an amount of 0.35-3.0% BWE. In another embodiment, one or more emulsifying agents for use in chip seal, scrub seal, or SAMI seal asphalt paving compositions are present in the composition in an amount of 0.35-1% BWE. In another embodiment, one or more emulsifying agents for use in rejuvenating seal or texture seal asphalt paving compositions are present in the composition in an amount of 0.5-1.8% BWE. In another embodiment, one or more emulsifying agents for use in cold in-place recycling or hot in-place recycling asphalt paving compositions are present in the composition in an amount of 1.5-3% BWE.

In still another embodiment, one or more emulsifying agents are present at greater than 0.1% BWE. In still another embodiment, one or more emulsifying agents are present at greater than 0.2% BWE. In a further embodiment, one or more emulsifying agents are present at greater than 0.3% BWE. In a further embodiment, one or more emulsifying agents are present at greater than 0.4% BWE. In a further embodiment, one or more emulsifying agents are present at greater than 0.5% BWE. In another embodiment, one or more emulsifying agents are present at greater than 0.75% BWE. In another embodiment, one or more emulsifying agents are present at greater than 1.0% BWE. In still another embodiment, one or more emulsifying agents are present at less than 7.0% BWE. In still another embodiment, one or more emulsifying agents are present at less than 6.0% BWE. In still another embodiment, one or more emulsifying agents are present at less than 5.0% BWE. In yet another embodiment, one or more emulsifying agents are present at less than 4.0% BWE. In yet another embodiment, one or more emulsifying agents are present at less than 3.0% BWE. In yet another embodiment, one or more emulsifying agents are present at less than 2.0% BWE.

1. Cationic

Asphalt paving compositions provided herein can be cationic. Emulsifying agents in cationic asphalt paving compositions can be derived from long-chain fatty acids and their acidic salts. The fatty acids can be derivatives of naturally occurring oils and fats, or they can be synthetic. In some embodiments, the fatty acids can be amidoamines, imidazolines, fatty amines, fatty diamines, fatty quaternary ammonium compounds or ethoxylated derivatives. The non-polar tails of the fatty acids are hydrophobic and can align inward toward the asphalt particles. The polar ends of the fatty acids are hydrophilic and provide solubility in water. The emulsifying agent molecules that surround an asphalt particle can impart a positive charge to the surface of the asphalt particle. Examples of cationic emulsifying agents include, but are not limited to, AA-86, AA-89, GE-F, MQK-1M, MQ3, MSS, R-11, R-66, R-99, SBT and W-5 of the Indulin brand and Pass R chemical package (MeadWestvaco Corp., Charleston, S.C.), C-450, E-9, E-11, E-11 HF, E-16, E-4819, EM-44A, EM48, 103, and 404 of the Redicote brand (AkzoNobel, Amsterdam, Netherlands), and Asfier N480L (Kao Chemicals, High Point, N.C.).

2. Anionic

Asphalt paving compositions provided herein can be anionic. Emulsifying agents in anionic asphalt paving compositions can be derived from long-chain fatty acids reacted with a base to form a salt. Such fatty acids can be derivatives of naturally occurring oils and fats, or they can be synthetic. In some embodiments, the fatty acids can be wood or paper-processing derivatives such as hydroxystearic acid, lignin sulfonates, rosin acids or tall oil fatty acids. In other embodiments, the fatty acids can be petroleum sulfonates such as alphaolefin sulfonates. In still other embodiments, the fatty acids can be from lauric, linoleic, myristic, palmitic, oleic or ricinoleic acids. In some embodiments, the base can be caustic potash (KOH) or caustic soda (NaOH). The non-polar tails of the fatty acids are hydrophobic and can align inward toward the asphalt particles. The polar ends of the fatty acids are hydrophilic and provide solubility in water. The emulsifying agent molecules that surround an asphalt particle can impart a negative charge to the surface of the asphalt particle. Examples of anionic emulsifying agents include, but are not limited to, some of the Indulin brand of emulsifying agents, such as W-5 (MeadWestvaco Corp., Charleston, S.C.).

3. Nonionic

Asphalt paving compositions provided herein can be nonionic. Emulsifying agents in nonionic asphalt paving compositions can be derived from neutrally charged long-chain fatty acids. The fatty acids can be derivatives of naturally occurring oils and fats, or they can be synthetic. In some embodiments, the emulsifying agent in nonionic asphalt paving compositions can include long chain polyoxyethylene or polyoxypropylene groups in fatty acid, alcohol, amide or amine molecules. These emulsifying agents can be hydrophilic due to oxygenated side chains (i.e., polyoxyethylene or polyoxypropylene chains combined with the oil-soluble fatty acid, alcohol amine or amide component of the molecule). Examples of nonionic emulsifying agents include, but are not limited to, Indulin XD-70 (MeadWestvaco Corp., Charleston, S.C.) and Berol 291, Redicote E-47, and the Witconol brand of nonyl phenol ethoxylates (AkzoNobel, Amsterdam, Netherlands).

Rejuvenating Agent

In various aspects, the asphalt paving compositions provided by the present disclosure may also contain one or more rejuvenating agents. The rejuvenating agent may be any rejuvenating agent known in the art. Rejuvenating agents include, but are not limited to, naphthenic or paraffinic distillates, deasphalted vacuum residue solvents comprising aromatic hydrocarbons, or other complex combinations of aromatic hydrocarbons. Rejuvenating agents suitable for use in the compositions provided by the present disclosure may have an RA-1 to RA-5 grade.

An example of a rejuvenating agent is a composition derived from coal tar that comprises a mixture of di-, tri- and tetracyclic aromatic compounds and their alkyl homologs containing lower alkyl groups together with a significant amount of phenolic and hydroxy derivatives (McGovern, U.S. Pat. No. 4,661,378).

Another example of a rejuvenating agent is a recycling agent. For example, a recycling agent can contain the maltene (essential oil) fraction of asphalt. In some variations, a recycling agent can contain a subset of the maltene fraction of asphalt such as one or more of polar resins, aromatic oils or saturate oils. Alternatively, the recycling agent can contain a relatively high percentage of aromatic oils and polar materials. Examples of suitable recycling agents include the Hydrolene brand of asphalt modifiers (HollyFrontier/Sunoco, Tulsa, Okla.) and the Cyclogen and Reclamite brands of asphalt preservation materials (Tricor Refining, LLC, Bakersfield, Calif.). In some implementations, the Reclamite is Reclamite-B.

Another example of a rejuvenating agent is a composition that includes a predominantly maltene recycling agent, a rubbery polymer or latex selected from styrene-butadiene-styrene, styrene butadiene rubber, neoprene latex and natural rubber, an emulsifying agent, and water (Koleas, U.S. Pat. No. 5,180,428, which is incorporated by reference herein in its entirety). Another example is a composition that includes an asphalt binder, water, a cationic emulsifying agent, a recycling agent and a cationic co-agglomerated styrene butadiene rubber latex, which includes sulfur and a vulcanizing agent (Takamura, U.S. Pat. No. 7,357,594).

In various aspects, an asphalt paving composition provided by the present disclosure can comprise one or more rejuvenating agents in an amount of 1-95% of the total weight of the asphalt paving composition, or by weight of emulsion (BWE). In one embodiment, one or more rejuvenating agents are present in the composition in an amount of 1-70% BWE. In another embodiment, one or more rejuvenating agents are present in the composition in an amount of 1-20% BWE. In another embodiment, one or more rejuvenating agents are present in the composition in an amount of 1-12% BWE. In another embodiment, one or more rejuvenating agents for use in cold in-place recycling or hot in-place recycling asphalt paving compositions are present in the composition in an amount of 1-6% BWE. In another embodiment, one or more rejuvenating agents for use in chip seal, scrub seal, or SAMI seal asphalt paving compositions are present in the composition in an amount of 6-12% BWE. In another embodiment, one or more rejuvenating agents for use in rejuvenating seal or texture seal asphalt paving compositions are present in the composition in an amount of 2-4% BWE.

In still another embodiment, one or more rejuvenating agents are present at greater than 1% BWE. In still another embodiment, one or more rejuvenating agents are present at greater than 2% BWE. In still another embodiment, one or more rejuvenating agents are present at greater than 3% BWE. In still another embodiment, one or more rejuvenating agents are present at greater than 4% BWE. In still another embodiment, one or more rejuvenating agents are present at greater than 5% BWE. In still another embodiment, one or more rejuvenating agents are present at greater than 6% BWE. In yet another embodiment, one or more rejuvenating agents are present at less than 95% BWE. In yet another embodiment, one or more rejuvenating agents are present at less than 75% BWE. In yet another embodiment, one or more rejuvenating agents are present at less than 50% BWE. In yet another embodiment, one or more rejuvenating agents are present at less than 25% BWE. In yet another embodiment, one or more rejuvenating agents are present at less than 15% BWE. In yet another embodiment, one or more rejuvenating agents are present at less than 10% BWE.

Without being limited to any mechanism or mode of action, rejuvenating agents increase the life span of asphalt pavement. Rejuvenating agents can penetrate asphalt to restore essential oils (maltenes), soften asphalt, revitalize or reactivate binder properties, and/or help aggregates adhere to and repair damage within the asphalt matrix. Rejuvenating agents increase ductility, increase flexibility, reduce viscosity, reduce brittleness, reduce ravel, and/or enrich oxidized pavement. Rejuvenating agents can form a polymer-rich, thin, stress-absorbing membrane that can strongly adhere to an underlying pavement. Rejuvenating agents can seal pavement and can make pavement resistant to fuels, oils, water and salts. Inclusion of one or more rejuvenating agents in the presently disclosed asphalt paving compositions can impart the asphalt paving compositions with a wide range of rejuvenation properties such that the asphalt paving composition is suitable for use in a wide range of applications.

Polymers

In various aspects, the asphalt paving compositions provided by the present disclosure may also contain one or more polymers. The polymers can be natural or synthetic. The polymers can be fuel resistant. In some embodiments, the polymers are elastomeric. In some embodiments, the polymers are plastomeric.

Example of polymers include, but are not limited to, acrylic, acrylic terpolymer, acrylonitrile-butadiene, butyl rubber, ethylene methacrylate copolymer, ethylene vinyl acetate copolymer, ethylene vinyl chloride, natural rubber, nitrile, polychloroprene (neoprene), polyurethane, polyvinylidene chloride, polyvinyl acetate, polyvinyl alcohol, silicone, styrene-butadiene rubber, vinylacrylic, vinyl acetate-ethylene, vinyl ester copolymer, and block copolymers such as styrene acrylate, styrene butadiene, styrene-ethylene-vinyl acetate and sytrene-isoprene. Polymers can be added to an asphalt paving composition in any form known in the art including, but not limited to, crumb, pellet, powder or water-suspended form. In some embodiments, suitable polymers for use in the present compositions include PA-AS-1 polychloroprene polymer.

Polymers add strength, increase elasticity, increase ductility, decrease brittleness, improve adhesion, improve cohesion, increase durability, extend life, and/or improve temperature stability of an asphalt paving composition. Polymers can reduce pavement cracking, such as that caused by thermal stresses and repetitive loads. Polymers can decrease rutting, such as that due to plastic or inelastic deformations of asphalt pavement mixtures. Polymer-modified asphalt paving compositions can be less brittle at low temperatures to resist cracking. Polymer-modified asphalt paving compositions can be stiffer at high temperatures to resist rutting and bleeding.

In various aspects, an asphalt paving composition provided by the present disclosure can comprise one or more polymers in an amount of 0.05-6.0% of the total weight of the asphalt paving composition, or by weight of emulsion (BWE). In one embodiment, one or more polymers are present in the composition in an amount of 0.1-4.0% BWE. In another embodiment, one or more polymers for use in cold in-place recycling or hot in-place recycling asphalt paving compositions are present in the composition in an amount of 0.1-1.0% BWE. In another embodiment, one or more polymers for use in chip seal, scrub seal, or SAMI seal asphalt paving compositions are present in the composition in an amount of 2.0-4.0% BWE. In another embodiment, one or more polymers for use in rejuvenating seal or texture seal asphalt paving compositions are present in the composition in an amount of 2.0-2.5% BWE.

In still another embodiment, one or more polymers are present at greater than 0.05% BWE. In still another embodiment, one or more polymers are present at greater than 0.1% BWE. In still another embodiment, one or more polymers are present at greater than 0.5% BWE. In still another embodiment, one or more polymers are present at greater than 1.0% BWE. In still another embodiment, one or more polymers are present at greater than 1.5% BWE. In still another embodiment, one or more polymers are present at greater than 2.0% BWE. In yet another embodiment, one or more polymers are present at less than 6.0% BWE. In yet another embodiment, one or more polymers are present at less than 5.0% BWE. In yet another embodiment, one or more polymers are present at less than 4.0% BWE. In yet another embodiment, one or more polymers are present at less than 3.0% BWE. In yet another embodiment, one or more polymers are present at less than 2.0% BWE.

Water

In various aspects, asphalt paving compositions provided by the present disclosure can also comprise water in an amount up to 75% of the total weight of the asphalt paving composition, or by weight emulsion (BWE). In some embodiments, water can be combined with an emulsifying agent in a combined amount of 35-40% BWE before being used in an asphalt paving composition.

Setting

Asphalt paving compositions coalesce (i.e., set or break) at different rates. Asphalt paving compositions can be slow setting, rapid setting, or medium setting. “Slow,” “rapid,” and “medium” are relative terms used in the art to define three well known classes of setting rates. Actual setting times observed in the field typically depend on the type of emulsifying agent used, as well as other factors. For example, ambient temperature, humidity and wind speed affect water evaporation rates, emulsifying agent migration and emulsifying agent water release characteristics. These effects can change the rate at which an asphalt paving composition sets.

Properties of Asphalt Paving Compositions

The compositions provided herein are highly workable and forgiving while maintaining toughness and durability. In various aspects, the asphalt paving compositions provide improved properties, such as a higher asphaltene content and increased resistance to oxidation (weathering), compared to known compositions. As asphalts age, the asphaltene content of refined asphalts increases, and the refined asphalts lose their flexibility and ability to bind. By comparison, natural asphalt, such as Gilsonite, has already been well oxidized (i.e., weathered) and thus does not suffer the same aging effects as refined asphalts.

In various aspects, the asphalt paving compositions provide improved dynamic shear characteristics. Dynamic shear relates to the high temperature properties of asphalt paving compositions. The original dynamic shear of modified asphalt test samples and neat asphalt test samples were tested as described in Example 4. Results are presented in Table 1, Row C. The results demonstrate that the modified asphalt test samples provided by the present disclosure had original dynamic shear values of at least 1.00 kPa at 82° C. or at 70° C., and therefore passed the original dynamic shear test at 82° C. or at 70° C., respectively. In contrast to the modified asphalt test samples, most neat asphalt test samples passed the original dynamic shear test at only 64° C. Modified asphalt test samples generally passed the original dynamic shear test at higher temperatures, which indicates that they have improved high temperature properties compared to neat asphalts.

The asphalt paving compositions provided herein also exhibit improved rolling thin film oven (RTFO) dynamic shear. RTFO dynamic shear values provide information about how a material will age early in its life. The RTFO dynamic shear of modified asphalt test samples and neat asphalt test samples were tested as described in Example 5. Results are presented in Table 1, Row D. The results demonstrate that modified asphalt test samples had RTFO dynamic shear values of at least 2.2 kPa at 82° C. or at 70° C., and therefore passed the RTFO dynamic shear test at 82° C. or at 70° C., respectively. In contrast to the modified asphalt test samples, most neat asphalt test samples passed the RTFO dynamic shear test at only 64° C. Modified asphalt test samples generally passed the RTFO dynamic shear test at higher temperatures, which indicates that they age better than neat asphalts early in their service lives.

The asphalt paving compositions provided herein can also provide improved pressure aging vessel (PAV) dynamic shear over previous asphalts. PAV dynamic shear values provide intermediate information about an asphalt paving material's performance properties. The PAV dynamic shear of modified asphalt test samples and neat asphalt test samples were tested as described in Example 6. Results are presented in Table 1, Row E. The results demonstrate that most modified asphalt test samples had PAV dynamic shear values of less than 5000 kPa at 28° C. or below, and therefore passed the PAV dynamic shear test at 28° C. or below, respectively. In contrast to the modified asphalt test samples, most neat asphalt test samples passed the PAV dynamic shear test at 25° C. or above. Modified asphalt test samples generally passed the PAV dynamic shear test at lower temperatures, which indicates that they have improved properties compared to neat asphalts.

The asphalt paving compositions provided herein also demonstrate improved flexural creep stiffness. Flexural creep stiffness describes the low-temperature stress-strain-time response of an asphalt binder at a given test temperature within the range of linear viscoelastic response. The flexural creep stiffness of modified asphalt test samples and neat asphalt test samples were tested as described in Example 7. Results are presented in Table 1, Rows F through I. The results demonstrate that modified asphalt test samples passed the flexural creep stiffness test at −12° C. In contrast to the modified asphalt test samples, a neat asphalt test sample passed the flexural creep stiffness test at only 0° C. Modified asphalt test samples generally passed the flexural creep stiffness test at lower temperatures, which indicates that they have improved low-temperature stress-strain-time responses than neat asphalt test samples.

The presently disclosed asphalt paving compositions meet industry performance requirements over a wider range of temperatures than known compositions. As described in Example 8, the results of Examples 4 to 7 were analyzed to determine the temperature range over which each test sample met the asphalt industry's required performance criteria. Performance over a working temperature range helps to evaluate and compare test samples because the test samples are thermoplastic compositions that perform differently at different temperatures.

Results are presented in Table 1, Row L. Results demonstrate that all but one of the modified asphalt test samples met the performance criteria over a 92° C. to 104° C. temperature range. By comparison, the neat asphalt test samples met the performance criteria over a lower temperature range. Specifically, the neat asphalt test samples met the performance criteria over an 80° C. to 86° C. temperature range. Modified asphalt test samples met the performance criteria over larger temperature ranges than neat asphalt test samples, which indicates that the modified asphalts have improved performance over larger temperature ranges and can be used over a larger range of working temperatures and paving conditions than neat asphalts.

Performance is improved regardless of the quality of the asphalt, which allows a wider range of asphalt grades from a wider range of geographic sources to be used. This reduces the cost of raw materials without sacrificing quality of the resulting pavement.

Uses of the Asphalt Paving Compositions

The asphalt paving compositions disclosed herein can be used for any pavement application known in the art. Types of pavement applications include preserving new asphalt pavements, restoring and rejuvenating aged asphalt pavements, rejuvenating crack filling, and adding positive texture to cracked, oxidized, and/or deteriorated asphalt pavements. Examples of pavement applications include, but are not limited to, chip seal, flexible interlocking layer, fog seal (including preservation fog seal and rejuvenating fog seal), sand seal, scrub seal, stress absorbing membrane interlayer (SAMI) seal, texture seal, surface dressing, cold in place recycling, hot in place recycling, and full-depth reclamation.

In one embodiment, asphalt paving compositions for use in chip sealing, scrub sealing, or SAMI sealing comprise a modified asphalt at 52-58% BWE, one or more emulsifying agents at 0.35-1% BWE, one or more rejuvenating agents at 6-12% BWE, and one or more polymers at 2.0-4.0% BWE.

In another embodiment, asphalt paving compositions for use in rejuvenating seal or texture seal comprise a modified asphalt at 58-61% BWE, one or more emulsifying agents at 0.5-1.8% BWE, one or more rejuvenating agents at 2-4% BWE, and one or more polymers at 2.0-2.5% BWE.

In another embodiment, asphalt paving compositions for use in cold in-place recycling or hot in-place recycling comprise a modified asphalt at 58-65% BWE, one or more emulsifying agents at 1.5-3% BWE, one or more rejuvenating agents at 1-6% BWE, and one or more polymers at 0.1-1.0% BWE.

### EXAMPLES

The following examples illustrate various aspects of the disclosure and should not be considered limiting. AASHTO protocols are available at www.transportation.org; ASTM protocols are available at www.astm.org.

### Example 1

### Test Samples

Modified asphalt test samples were prepared by combining soft asphalts from various sources in the United States and Europe with Gilsonite. For each modified asphalt test sample, an asphalt and Gilsonite were combined and mixed at 350° F. to 380° F. for approximately 2 hours.

The following modified asphalt test samples were prepared: 80% w/w Valero BAP & 20% w/w Gilsonite; 83% w/w ASI Europe & 17% w/w Gilsonite; 82% w/w ASI Salt Lake blend Foreland AC & 18% w/w Gilsonite; 85% w/w “Nynas” ASI Europe & 15% w/w Gilsonite; 80% w/w San Joaquin & 20% w/w Gilsonite; 85% w/w AC-1/Nred(50/50) & 15% w/w Gilsonite; 82% w/w AC-1 & 18% w/w Gilsonite; 80% w/w Nred & 20% w/w Gilsonite; 84% w/w Suncor 300/400 & 16% w/w Gilsonite; and 85% w/w ASI Europe & 15% w/w Gilsonite.

Neat asphalt test samples were also prepared for comparison to the modified asphalt test samples. Neat asphalt test samples included Cenex PG 64-22 and Valero PG 70-10.

### Example 2

### Penetration

Test samples were prepared as described in Example 1. The penetration of each test sample was tested at 25° C. according to the AASHTO T-49 (ASTM D-5) protocol. Penetration values indicate how hard an asphalt material is, and hardness can indicate loss of ductility. Higher penetration values indicate softer asphalt materials; lower penetration values indicate harder asphalt materials. The targeted penetration was 40 decimillimeters (dmm), and the amount of Gilsonite was adjusted in the modified asphalt test samples to achieve the desired penetration.

Results are presented in Table 1, Row A. The results demonstrate that the modified asphalt test samples had penetration values ranging from 28 to 48 dmm. The neat asphalt test samples had penetration values ranging from 24 to 58 dmm.

TABLE 1

| | | | MODIFIED ASPHALT TEST SAMPLES | | | |
|---|---|---|---|---|---|---|
| | | | | | 82% ASI Salt Lake | 85% “Nynas” |
| | | | 80% Valero BAP | 83% ASI Europe | blend Foreland AC | ASI Europe |
| | TEST | TEST NO. | & 20% Gilsonite | & 17% Gilsonite | & 18% Gilsonite | & 15% Gilsonite |
| A | Penetration @ | AASHTO T-49 | 48 | 28 | 35 | 42 |
| | 25° C. (dmm) | ASTM D-5 | | | | |
| B | Rotational viscosity @ | AASHTO T-316 | 0.631 | 1.671 | 1.112 | 0.531 |
| | 135° C. (Pa · s) | ASTM D-4402 | | | | |
| C | Dynamic | AASHTO T-315 | 1.31 @ 70° C. | 1.25 @ 82° C. | 1.18 @ 82° C. | 1.02 @ 70° C. |
| | Shear G*/sin δ (kPa) | ASTM D-7175 | | | | |
| D | RTFO Residue Dynamic | AASHTO T-315 | 5.01 @ 70° C. | 5.3 @ 82° C. | 3.39 @ 82° C. | 2.31 @ 70° C. |
| | Shear G*/sin δ (kPa) | ASTM D-7175 | | | | |
| E | PAV Dynamic | AASHTO T-315 | ND | ND | 3380 @ 34° C. | 3690 @ 28° C. |
| | Shear G*/sin δ (kPa) | ASTM D-7175 | | | | |
| F | Creep Stiffness Temp #1 s value | AASHTO T-313 | 120 @ −12° C. | 188 @ −12° C. | 152 @ −12° C. | 242 @ −12° C. |
| | (MPa @ test temperature) | ASTM D-6648 | | | | |
| G | Creep Stiffness Temp #1 m value | AASHTO T-313 | 0.342 @ −12° C. | 0.311 @ −12° C. | 0.334 @ −12° C. | 0.435 @ −12° C. |
| | (MPa @ test temperature) | ASTM D-6648 | | | | |
| H | Creep Stiffness Temp #2 s value | AASHTO T-313 | 267 @ −18° C. | ND | ND | ND |
| | (MPa @ test temperature) | ASTM D-6648 | | | | |
| I | Creep Stiffness Temp #2 m value | AASHTO T-313 | 0.279 @ −18° C. | ND | ND | ND |
| | (MPa @ test temperature) | ASTM D-6648 | | | | |
| J | High Temp at which sample meets | NA | 70 | 82 | 82 | 70 |
| | performance criteria (° C.) | | | | | |
| K | Low Temp at which sample meets | NA | −22 | −22 | −22 | −22 |
| | performance criteria (° C.) | | | | | |
| L | Temp range over which sample | NA | 92 | 104 | 104 | 92 |
| | meets performance criteria (° C.) | | | | | |

| | | MODIFIED ASPHALT TEST SAMPLES | | | | | |
|---|---|---|---|---|---|---|---|
| | | 80% San | 85% AC-1/Nred | | 80% | 84% Suncor | |
| | | Joaquin & | (50/50) & | 82% AC−1 | Nred & 20% | 300/400 | 85% ASI Europe |
| | TEST | 20% Gilsonite | 15% Gilsonite | & 18% Gilsonite | Gilsonite | & 16% Gilsonite | & 15% Gilsonite |
| A | Penetration @ | ND | 45 | 33 | 44 | 47 | ND |
| | 25° C. (dmm) | | | | | | |
| B | Rotational viscosity @ | 1.112 | 0.601 | 0.64 | 0.962 | 0.764 | 0.531 |
| | 135° C. (Pa · s) | | | | | | |
| C | Dynamic | 1.04 @ 82° C. | 1.13 @ 70° C. | 1.49 @ 70° .C | 1.18 @ 70° C. | 1.48 @ 70° C. | 1.02 @ 70° C. |
| | Shear G*/sin δ (kPa) | | | | | | |
| D | RTFO Residue Dynamic | 6.69 @ 82° C. | 2.98 @ 70° C. | 2.97 @ 70° C. | 3.39 @ 70° C. | 2.59 @ 70° C. | 2.28 @ 70° C. |
| | Shear G*/sin δ (kPa) | | | | | | |
| E | PAV Dynamic | 4400 @ 34° C. | 1180 @ 28° C. | 3900 @ 22° C. | 3220 @ 25° C. | 4810 @ 22° C. | 3690 @ 28° C. |
| | Shear G*/sin δ (kPa) | | | | | | |
| F | Creep Stiffness High | 184 @ −6° C. | 59.9 @ −6° C. | 56 @ −6° C. | 63.2 @ −6° C. | 48.4 @ −6° C. | 242 @ −12° C. |
| | Temp s value (MPa @ | | | | | | |
| | test temperature) | | | | | | |
| G | Creep Stiffness High | 0.311 @ −6° C. | 0.333 @ −6° C. | 0.315 @ −6° C. | 0.326 @ −6° C. | 0.448 @ −6° C. | 0.435 @ −12° C. |
| | Temp m value (MPa @ | | | | | | |
| | test temperature) | | | | | | |
| H | Creep Stiffness Low | ND | 110 @ −12° C. | 110 @ −12° C. | 99.2 @ −12° C. | 172 @ −18° C. | 358 @ −18° C. |
| | Temp s value (MPa @ | | | | | | |
| | test temperature) | | | | | | |
| I | Creep Stiffness Low | ND | 0.306 @ −12° C. | 0.306 @ −12° C. | 0.299 @ −12° C. | 0.300 @ −18° C. | 0.241 @ −18° .C |
| | Temp m value (MPa @ | | | | | | |
| | test temperature) | | | | | | |
| J | High temp at which | 82 | 70 | 70 | 70 | 70 | 70 |
| | sample still meets | | | | | | |
| | performance criteria (° C.) | | | | | | |
| K | Low temp at which | −16 | −22 | −22 | −16 | −28 | −22 |
| | sample still meets | | | | | | |
| | performance criteria (° C.) | | | | | | |
| L | Temp range over which | 98 | 92 | 92 | 86 | 98 | 92 |
| | sample meets performance | | | | | | |
| | criteria (° C.) | | | | | | |
| | | NEAT ASPHALT TEST SAMPLES | | | | | |
| | | Valero | Valero | Cenex | WR Refining | Sinclair | FHR |
| | TEST | PG 70-10 | AC-40 | PG 64-22 | PG 64-22 | PG 64-22 | PG 64-22 |
| A | Penetration @ | 24 | ND | 58 | ND | ND | ND |
| | 25° C. (dmm) | | | | | | |
| B | Rotational viscosity @ | 0.751 | 0.839 | 0.475 | 0.551 | 0.553 | 0.935 |
| | 135° C. (Pa · s) | | | | | | |
| C | Dynamic Shear | 1.47 @ 70° C. | 1.19 @ 70° C. | 1.21 @ 64° C. | 1.25 @ 64° C. | 1.32 @ 64° C. | 1.98 @ 64° C. |
| | G*/sin δ (kPa) | | | | | | |
| D | RTFO Residue Dynamic | 2.64 @ 70° C. | 2.32 @ 70° C. | 2.66 @ 64° C. | 2.93 @ 64° C. | 3.36 @ 64° C. | 4.96 @ 64° C. |
| | ShearG*/sin δ (kPa) | | | | | | |
| E | PAV Dynamic Shear | 1728 @ 34° C. | 4880 @ 25° C. | 3210 @ 25° C. | 3450 @ 25° C. | 3960 @ 25° C. | 4490 @ 22° C. |
| | G*/sin δ (kPa) | | | | | | |
| F | Creep Stiffness High | 83 @ 0° C. | 132 @ −6° C. | 220 @ −12° C. | 149 @ −12° C. | 140 @ −12° C. | 198 @ −12° C. |
| | Temp s value (MPa @ | | | | | | |
| | test temperature) | | | | | | |
| G | Creep Stiffness High | 0.364 @ 0° C. | 0.327 @ −6° C. | 0.315 @ −12° C. | 0.315 @ −12° C. | 0.311 @ −12° C. | 0.328 @ −12° C. |
| | Temp m value (MPa @ | | | | | | |
| | test temperature) | | | | | | |
| H | Creep Stiffness Low | ND | 291 @ −12° C. | ND | ND | ND | 377 @ −18° C. |
| | Temp s value (MPa @ | | | | | | |
| | test temperature) | | | | | | |
| I | Creep Stiffness Low | ND | 0.269 @ −12° C. | ND | ND | ND | 0.270 @ −18° C. |
| | Temp m value (MPa @ | | | | | | |
| | test temperature) | | | | | | |
| J | High temp at which | 70 | 70 | 64 | 64 | 64 | 64 |
| | sample still meets | | | | | | |
| | performance criteria (° C.) | | | | | | |
| K | Low temp at which | −10 | −16 | −22 | −22 | −22 | −22 |
| | sample still meets | | | | | | |
| | performance criteria (° C.) | | | | | | |
| L | Temp range over which | 80 | 86 | 86 | 86 | 86 | 86 |
| | sample meets performance | | | | | | |
| | criteria (° C.) | | | | | | |

NA - Not Applicable;
ND - No Data

### Example 3

### Rotational Viscosity

Test samples were prepared as described in Example 1. Rotational viscosity was tested at 135° C. according to the AASHTO T-316 (ASTM D-4402) protocol. Rotational viscosity values below 3 Pascal-seconds (Pass) indicate that a material is pliable enough at a given temperature such that it can be manageably pumped. Rotational viscosity values above 3 Pa·s indicate that a material is not manageable or pumpable without being heated to a higher temperature.

Results are presented in Table 1, Row B. The results demonstrate that all modified asphalt test samples and neat asphalt test samples had values below 3 Pa·s. All modified asphalt test samples and neat asphalt test samples therefore passed the rotational viscosity test at 135° C.

### Example 4

### Original Dynamic Shear

Test samples were prepared as described in Example 1. Original dynamic shear was tested according to the AASHTO T-315 (ASTM D-7175) protocol. Original dynamic shear values provide information about the high temperature properties of a test sample. Original dynamic shear values also provide information about whether a material is stiff enough to pave in given climatic conditions without failing. To meet the asphalt industry's required performance criteria (i.e., to pass the dynamic shear test), a sample must have an original dynamic shear value of at least 1.00 kilopascals (kPa) at a given test temperature at 10 rad/sec. A sample must also have an RTFO dynamic shear value of at least 2.2 kPa at the same temperature (see Example 5).

Results are presented in Table 1, Row C. The results demonstrate that the following modified asphalt test samples had original dynamic shear values of at least 1.00 kPa at 82° C., and therefore passed the original dynamic shear test at 82° C.: 83% ASI Europe & 17% Gilsonite; 82% ASI Salt Lake blend Foreland AC & 18% Gilsonite; and 80% San Joaquin & 20% Gilsonite. No neat asphalt test samples passed the original dynamic shear test at 82° C.

The results demonstrate that the following modified asphalt test samples had original dynamic shear values of at least 1.00 kPa at 70° C., and therefore passed the original dynamic shear test at 70° C.: 80% Valero BAP & 20% Gilsonite; 85% “Nynas” ASI Europe & 15% Gilsonite; 85% AC-1/Nred(50/50) & 15% Gilsonite; 82% AC-1 & 18% Gilsonite; 80% Nred & 20% Gilsonite; 84% Suncor 300/400 & 16% Gilsonite; and 85% ASI Europe & 15% Gilsonite.

In contrast to the modified asphalt test samples, the Cenex PG 64-22, WR Refining PG 64-22, Sinclair PG 64-22, and FHR PG 64-22 neat asphalt test samples passed the original dynamic shear test at only 64° C. Modified asphalt test samples passed the original dynamic shear test at higher temperatures, which indicates that they have improved high temperature properties compared to neat asphalts. The Valero PG 70-10 and Valero AC 70-10 neat asphalt test samples had original dynamic shear values of at least 1.00 kPa at 70° C., and therefore passed the original dynamic shear test at 70° C.

### Example 5

### Dynamic Shear of RTFO Residue

Test samples were subjected to a rolling thin-oven (RTFO) procedure according to the AASHTO T-240 (ASTM D-2872) protocol. RTFO simulates aging during hot mixing and placement of asphalt paving materials.

Dynamic shear of the RTFO residues was tested according to the AASHTO T-315 (ASTM D-7175) protocol. RTFO dynamic shear values provide information about how a material will age early in its life. To meet the asphalt industry's required performance criteria (i.e., to pass the RTFO dynamic shear test), a sample must have an RTFO dynamic shear value of at least 2.2 kPa at a given test temperature at 10 rad/sec. A sample must also have an original dynamic shear value of at least 1.0 kPa at the same temperature (see Example 4).

Results are presented in Table 1, Row D. The results demonstrate that the following modified asphalt test samples had RTFO dynamic shear values of at least 2.2 kPa at 82° C., and therefore passed the RTFO dynamic shear test at 82° C.: 83% ASI Europe & 17% Gilsonite; 82% ASI Salt Lake blend Foreland AC & 18% Gilsonite; and 80% San Joaquin & 20% Gilsonite. No neat asphalt test samples passed the RTFO dynamic shear test at 82° C.

The results demonstrate that the following modified asphalt test samples had RTFO dynamic shear values of at least 2.2 kPa at 70° C., and therefore passed the RTFO dynamic shear test at 70° C.: 80% Valero BAP & 20% Gilsonite; 85% “Nynas” ASI Europe & 15% Gilsonite; 85% AC-1/Nred(50/50) & 15% Gilsonite; 82% AC-1 & 18% Gilsonite; 80% Nred & 20% Gilsonite; 84% Suncor 300/400 & 16% Gilsonite; and 85% ASI Europe & 15% Gilsonite.

In contrast to the modified asphalt test samples, the Cenex PG 64-22, WR Refining PG 64-22, Sinclair PG 64-22, and FHR PG 64-22 neat asphalt test samples passed the RTFO dynamic shear test at only 64° C. Modified asphalt test samples passed the RTFO dynamic shear test at higher temperatures, which indicates that they have improved high temperature properties compared to neat asphalts. The Valero PG 70-10 and Valero AC 70-10 neat asphalt test sample had RTFO dynamic shear values of at least 2.2 kPa at 70° C., and therefore passed the RTFO dynamic shear test at 70° C.

### Example 6

### Dynamic Shear of PAV-Aged Samples

RTFO residues produced according to Example 5 were then subjected to a pressure aging vessel (PAV) procedure according to the AASHTO R-28 (ASTM D-6521) protocol. All test samples were aged at 100° C. except for Valero PG70-10 neat asphalt, which was tested at 110° C. based on its common use in hotter desert climatic conditions. PAV simulates aging during in-service life of asphalt paving materials.

Dynamic shear of the PAV-aged samples was tested according to the AASHTO T-315 (ASTM D-7175) protocol. PAV dynamic shear values provide intermediate information about an asphalt paving material's performance properties. To meet the asphalt industry's required performance criteria (i.e., to pass the PAV dynamic shear test), a sample must have a PAV dynamic shear value of at 5000 kPa or less at a given test temperature at 10 rad/sec.

Results are presented in Table 1, Row E. The results demonstrate that the following modified asphalt test samples had PAV dynamic shear values of less than 5000 kPa at 22° C., and therefore passed the PAV dynamic shear test at 22° C.: 82% AC-1 & 18% Gilsonite and 84% Suncor 300/400 & 16% Gilsonite.

The results demonstrate that the 80% Nred & 20% Gilsonite modified asphalt test sample had PAV dynamic shear values of less than 5000 kPa at 25° C., and therefore passed the PAV dynamic shear test at 25° C.

The results demonstrate that the following modified asphalt test samples had PAV dynamic shear values of less than 5000 kPa at 28° C., and therefore passed the PAV dynamic shear test at 28° C.: 85% “Nynas” ASI Europe & 15% Gilsonite; 85% AC-1/Nred(50/50) & 15% Gilsonite; and 85% ASI Europe & 15% Gilsonite.

The results demonstrate that the following modified asphalt test samples had PAV dynamic shear values of less than 5000 kPa at 34° C., and therefore passed the PAV dynamic shear test at 34° C.: 82% ASI Salt Lake blend Foreland AC & 18% Gilsonite and 80% San Joaquin & 20% Gilsonite.

In contrast to the modified asphalt test samples, most of the neat asphalt test samples passed the PAV dynamic shear test at 25° C. or greater. The Valero PG 70-10 neat asphalt test sample passed the PAV dynamic shear test at 34° C., and the Valero AC-40, Cenex PG 64-22, WR Refining PG 64-22, and Sinclair PG 64-22 neat asphalt test samples passed the PAV dynamic shear test at 25° C. Modified asphalt test samples passed the PAV dynamic shear test at lower temperatures, which indicates that they have improved properties compared to neat asphalts. The FHR PG 64-22 neat asphalt test sample had a PAV dynamic shear value of less than 5000 kPa at 22° C., and therefore passed the PAV dynamic shear test at 22° C.

### Example 7

### Flexural Creep Stiffness

Flexural creep stiffness of the PAV-aged samples produced according to Example 6 was tested according to the AASHTO T-313 (ASTM D-6648) protocol. Flexural creep stiffness describes the low-temperature stress-strain-time response of an asphalt binder at a given test temperature within the range of linear viscoelastic response. Flexural creep stiffness test results are presented in terms of flexibility (“s value”) and recovery (“m value”). S values below 300 megapascals (MPa) at a given test temperature at 60 sec indicate that a sample maintains flexibility at low temperatures. M values above 0.300 MPa at a given test temperature at 60 sec indicate that a sample recovers adequately from a deformed state. Flexural creep stiffness of each PAV-aged sample was tested at a given temperature (“Temp #1”). If the sample had an s value below 300 MPa and an m value above 0.300 MPa at Temp #1, it was often tested at a temperature 6 degrees lower (“Temp #2”) to determine if it had passable s and m values at the lower temperature as well.

Results are presented in Table 1, Rows F-I. The results demonstrate that the 84% Suncor 300/400 & 16% Gilsonite modified asphalt test samples had an s values below 300 MPa and an m value above 0.300 MPa at −18° C., and therefore passed the flexural creep stiffness test at −18° C.

The results demonstrate that the following modified asphalt test samples had s values below 300 MPa and m values above 0.300 MPa at −12° C., and therefore passed the flexural creep stiffness test at −12° C.: 80% Valero BAP & 20% Gilsonite; 83% ASI Europe & 17% Gilsonite; 82% ASI Salt Lake blend Foreland AC & 18% Gilsonite; 85% “Nynas” ASI Europe & 15% Gilsonite; 85% AC-1/Nred(50/50) & 15% Gilsonite; 82% AC-1 & 18% Gilsonite; and 85% ASI Europe & 15% Gilsonite.

The results demonstrate that the following modified asphalt test samples had s values below 300 MPa and m values above 0.300 MPa at −6° C., and therefore passed the flexural creep stiffness test at −6° C.: 80% San Joaquin & 20% Gilsonite and 80% Nred & 20% Gilsonite.

The Valero PG 70-10 neat asphalt test sample passed the flexural creep stiffness test at 0° C. and the Valero AC-40 neat asphalt test sample passed the flexural creep stiffness test at −6° C. The Cenex PG 64-22, WR Refining PG 64-22, Sinclair PG 64-22, and FHR PG 64-22 neat asphalt test samples passed the flexural creep stiffness test at −12° C.

### Example 8

### Temperature Ranges

The results of Examples 4 to 7 were analyzed to determine the temperature range over which each test sample met the asphalt industry's required performance criteria. Performance over a working temperature range helps to evaluate and compare test samples because the test samples are thermoplastic compositions that perform differently at different temperatures.

The highest tested temperature at which a given test sample passed the original and RTFO dynamic shear tests (“High Temp”) is reported in Table 1, Row J. The lowest tested temperature at which a given test sample passed the creep stiffness tests (“Low Temp”) is reported in Table 1, Row K. The Low Temp includes a 10° C. downward adjustment to accommodate the corresponding 10° C. upward shift in the AASHTO T-313 testing protocol. The difference between High Temp and Low Temp is reported in Table 1, Row L.

The results demonstrate that the following modified asphalt test samples met the performance criteria over a 104° C. temperature range: 83% ASI Europe & 17% Gilsonite and 82% ASI Salt Lake blend Foreland AC & 18% Gilsonite.

The results demonstrate that the following modified asphalt test samples met the performance criteria over a 98° C. temperature range: 80% San Joaquin & 20% Gilsonite and 84% Suncor 300/400 & 16% Gilsonite.

The results demonstrate that the following modified asphalt test samples met the performance criteria over a 92° C. temperature range: 80% Valero BAP & 20% Gilsonite; 85% “Nynas” ASI Europe & 15% Gilsonite; 85% AC-1/Nred(50/50) & 15% Gilsonite; 82% AC-1 & 18% Gilsonite; and 85% ASI Europe & 15% Gilsonite.

The results demonstrate that the 80% Nred & 20% Gilsonite modified asphalt test sample met the performance criteria over an 86° C. temperature range.

By comparison, the disclosed neat asphalts did not meet a temperature range of 90° C. The Valero PG 70-10 neat asphalt test sample met the performance criteria over an 80° C. temperature range, and the remaining neat asphalt test samples met the performance criteria over an 86° C. temperature range. Modified asphalt test samples met the performance criteria over larger temperature ranges than neat asphalt test samples. Modified asphalts have improved performance over larger temperature ranges than neat asphalts, which allows the modified asphalts to be used over a larger range of working temperatures, in a broader set of paving conditions, and for a greater variety of paving applications than neat asphalts.

### Example 9

### Manufacturing an Asphalt Paving Composition

An exemplary asphalt paving composition is prepared by heating an asphalt in an agitated melting tank at 250° F. to 400° F. The asphalt ranges from AC-1 to AC-30, and has a penetration of 20-550 dmm. When the desired temperature is reached, a natural asphalt is added at 2.0 to 60.0% w/w at a rate such that the temperature in the melting tank does not fall below the desired minimum temperature. The asphalt and natural asphalt are agitated under heat until the natural asphalt is completely dissolved and a homogenous blended modified asphalt material is produced. A sample of the modified asphalt material is taken for quality control testing.

The proportions of asphalt and natural asphalt are selected such that the resulting modified asphalt has an enhanced asphaltene content, improved low temperature flexibility, improved high temperature fatigue, increased anti-oxidant properties, and increased weathering properties compared to unmodified asphalt.

Next, basestock is prepared by adding a rejuvenating agent to the modified asphalt. The basestock is heated at, for example, 275° F. to 350° F. and agitated until homogenous. The rejuvenating agent is added at 1.0 to 95.0% BWE, depending on the application for which the resulting asphalt paving composition will be used. A sample of the basestock is taken for quality control testing.

Separately, an emulsifier solution is prepared by combining one or more emulsifying agents (e.g. Pass CR, Pass QB, Pass R) and water, and stifling until the solution is homogenous. The emulsifying agent comprises 0.25% to 5.0% BWE. The temperature of the emulsifier solution ranges from, for example, 75° F. to 140° F.

The emulsifier solution is pumped into a colloidal mill. The basestock is added to the emulsifier solution and mixed until homogeneous. The basestock comprises 25 to 75% BWE.

A polymer is added at 0.1 to 5.0% BWE. The polymer is blended into the emulsifier solution or injected into the input piping of the emulsifier solution before the solution is transferred into the colloidal mill. A sample of the exemplary asphalt paving composition is taken for quality control testing.

The above specification and examples provide a complete description of the components and use of exemplary embodiments of asphalt paving compositions. Although various embodiments have been described above with a certain degree of particularity, or with reference to one or more individual embodiments, those skilled in the art could make numerous alterations to the disclosed embodiments without departing from the spirit or scope of this disclosure. Other embodiments are therefore contemplated. All matter contained in the above description is illustrative only of particular embodiments and not limiting. Changes in detail or structure may be made without departing from the basic elements described herein.

1. An asphalt paving composition comprising:
an asphalt;
a natural asphalt;
one or more emulsifying agents;
one or more rejuvenating agents; and
one or more polymers.

2. The asphalt paving composition of claim 1, further comprising water.

3. The asphalt paving composition of claim 1, wherein the natural asphalt is an asphaltite.

4. The asphalt paving composition of claim 1, wherein the natural asphalt is Gilsonite.

5. The asphalt paving composition of claim 1, wherein the one or more emulsifying agents comprise 0.1-7.0% by weight of the total weight of the composition.

6. The asphalt paving composition of claim 5, wherein the one or more emulsifying agents comprise 0.35-1% by weight of the total weight of the composition.

7. The asphalt paving composition of claim 5, wherein the one or more emulsifying agents comprise 0.5-1.8% by weight of the total weight of the composition.

8. The asphalt paving composition of claim 5, wherein the one or more emulsifying agents comprise 1.5-3% by weight of the total weight of the composition.

9. The asphalt paving composition of claim 1, wherein the one or more rejuvenating agents comprise 1-95% by weight of the total weight of the composition.

10. The asphalt paving composition of claim 9, wherein the one or more rejuvenating agents comprise 6-12% by weight of the total weight of the composition.

11. The asphalt paving composition of claim 9, wherein the one or more rejuvenating agents comprise 2-4% by weight of the total weight of the composition.

12. The asphalt paving composition of claim 9, wherein the one or more rejuvenating agents comprise 1-6% by weight of the total weight of the composition.

13. The asphalt paving composition of claim 1, wherein the rejuvenating agent is Reclamite B.

14. The asphalt paving composition of claim 1, wherein the one or more polymers comprise 0.05-6.0% by weight of the total weight of the composition.

15. The asphalt paving composition of claim 14, wherein the one or more polymers comprise 2.0-4.0% by weight of the total weight of the composition.

16. The asphalt paving composition of claim 14, wherein the one or more polymers comprise 2.0-2.5% by weight of the total weight of the composition.

17. The asphalt paving composition of claim 14, wherein the one or more polymers comprise 0.1-1.0% by weight of the total weight of the composition.

18. The asphalt paving composition of claim 1, wherein one of the one or more polymers is a polychloroprene polymer.

19. The asphalt paving composition of claim 18, wherein the polychloroprene polymer is PA-AS-1 polychloroprene polymer.

20. The asphalt paving composition of claim 1, wherein one of the one or more polymers is a styrene butadiene rubber polymer.

21. The asphalt paving composition of claim 1, wherein the natural asphalt is Gilsonite, the rejuvenating agent is Reclamite B, and one of the one or more polymers is a PA-AS-1 polychloroprene polymer.

22. The asphalt paving composition of claim 1, wherein the asphalt and the natural asphalt are combined to form a modified asphalt.

23. The asphalt paving composition of claim 22, wherein the modified asphalt comprises 45-70% by weight of the total weight of the composition.

24. The asphalt paving composition of claim 22, wherein the modified asphalt is selected from: 80% w/w Valero BAP & 20% w/w Gilsonite; 83% w/w ASI Europe & 17% w/w Gilsonite; 82% w/w ASI Salt Lake blend Foreland AC & 18% w/w Gilsonite; 85% w/w “Nynas” ASI Europe & 15% w/w Gilsonite; 80% w/w San Joaquin & 20% w/w Gilsonite; 85% w/w AC-1/Nred(50/50) & 15% w/w Gilsonite; 82% w/w AC-1 & 18% w/w Gilsonite; 80% w/w Nred & 20% w/w Gilsonite; 84% w/w Suncor 300/400 & 16% w/w Gilsonite; and 85% w/w ASI Europe & 15% w/w Gilsonite.

25. The asphalt paving composition of claim 1, wherein the composition meets paving industry performance criteria over 86° C. or more.

26. The asphalt paving composition of claim 25, wherein the composition meets paving industry performance criteria over 92° C. or more.
